(19) United States
(12) Patent Application Publication
(10) Pub. No.: US 2010/0300727 A1
(43) Pub. Date: Dec. 2, 2010

(54) Cable Comprising Bedding with Reduced Amount of Volatile Compounds

(76) Inventors: Bernt-Ake Sultan, Stenungsund (SE); Wendy Loyens, Stenungsund (SE); James Elliott Robinson, Genval (BE); Susanna Lieber, Melle (DE); Herbert Baur, Ludinghausen (DE)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 12/678,061

(22) PCT Filed: Sep. 11, 2008
(86) PCT No.: PCT/EP08/07497

§ 371 Date: Apr. 27, 2010

(30) Foreign Application Priority Data
Sep. 12, 2007 (EP) 07017915.5

(51) Int. Cl. H01B 7/00; C09D 123/00; H01B 3/30; H01B 7/295

(52) U.S. Cl. 174/113 R; 524/570; 174/110 SR; 174/120 R

(57) ABSTRACT

The present invention relates to a cable comprising one or more insulated conductors which are embedded in a bedding composition, which comprises
a) a polymer resin (A) and
b) an inorganic filler (B),
   wherein the polymer resin (A) comprises an olefin homo- and/or copolymer (A.1) which has a weight average molecular weight M_{w} of 10,000 g/mol or more and a molecular weight distribution MWD of 4.5 or lower and, in a second aspect, to a cable comprising one or more insulated conductors which are embedded in a bedding composition, which comprises
a) a polymer resin (A) and
b) an inorganic filler (B),
   wherein the heat release rate HRR of the composition at any time within is the period from 0 s to 200 s after ignition does not exceed a maximum of 80 kW measured with cone calorimetry according to ISO 5660-1. The bedding may also comprise a bedding layer provided between said one or more insulated conductors and an outer sheath layer, wherein the bedding layer comprises the above bedding composition.

The present invention relates to a cable comprising one or more insulated conductors which are embedded in a bedding composition comprising a polymer and an inorganic filler with improved flame retardant properties.

A typical electric power cable generally comprises one or more conductors in a cable core, which is optionally surrounded by several layers of polymeric materials. In particular, the construction of electric power cables for low voltage, i.e. voltage of below 6 kV, or control, computer and telecommunication cables usually comprises a conductor which is surrounded by an insulation layer of polymeric material. Optionally, one or more of such insulated conductors are surrounded by a common outer sheath layer, the jacket.

Especially in cables comprising more than one insulated conductor, usually a so-called bedding is present between the insulated conductors and the common outer sheath layer. The purpose of such a bedding is manifold. For example, it fills the gaps between the insulated conductors and the outer sheath so as to allow for a round cross-section of the cable, it is used for embedding of e.g. screens, tapes, etc., it protects the cable against mechanical damage, and it seals the cable against water penetration.

A “bedding” in the sense of the present invention may also comprise a layer present between one or more insulated conductors and a common outer sheath layer. There might be a semiconducting layer intop of the insulating layer.

In general, for cables and wires used in constructions like buildings, industries, vehicles, ships, tunnels etc. good flame resistance is required. However, the polymers, especially polyolefins, which are used in the cables and wires, are inherently combustible materials.

It is hence an object of the present invention to improve the flame retardant properties of a cable comprising an insulated conductor and a bedding surrounding the conductor(s). Usually the cable has an outer sheeting, also called jacket for mechanical protection. At the same time, the cable should have low production costs and good processability as well as mechanical properties.

In the past, comparatively little attention has been paid to the bedding in regard to its effects on the flame retardant properties of a cable. It has been found now that the flame retardant properties of a cable comprising one or more insulated conductor(s) and a bedding can be improved if the presence of combustible volatile and/or low molecular weight species in the bedding is reduced.

Therefore, the present invention according to a first aspect provides a cable comprising one or more insulated conductors which are embedded in a bedding composition, which comprises
a) a polymer resin (A) and
b) an inorganic filler (B),
   wherein the polymer resin (A) comprises an olefin homo- and/or copolymer

(A.1) which has a weight average molecular weight M_{w} of 10,000 g/mol or more and a molecular weight distribution MWD of 5 or lower.

According to a second aspect, the present invention provides a cable comprising one or more insulated conductors which are covered by a bedding layer provided between said one or more insulated conductors and an outer sheath layer, wherein the bedding layer comprises a bedding composition comprising
(a) a polymer resin (A) and
(b) an inorganic filler (B),
   wherein the polymer resin (A) comprises an olefin homo- and/or copolymer (A.1) which has a weight average molecular weight M_{w} of 10,000 g/mol or more and a molecular weight distribution MWD of 5 or lower.

According to a third aspect, the present invention provides a cable comprising one or more insulated conductors which are embedded in a bedding composition, which comprises
a) a polymer resin (A) and
b) an inorganic filler (B),
   wherein the heat release rate HRR of the bedding composition at any time within the period from 0 s to 200 s after ignition does not exceed a maximum of 80 kW measured with cone calorimetry according to ISO 5660-1.

According to a fourth aspect, the present invention provides a cable comprising one or more insulated conductors which are covered by a bedding layer provided between said one or more insulated conductors and an outer sheath layer, wherein the bedding layer comprises a bedding composition comprising
a) a polymer resin (A) and
b) an inorganic filler (B),
   wherein the heat release rate HRR of the bedding composition at any time within the period from 0 s to 200 s after ignition does not exceed a maximum of 80 kW measured with cone calorimetry according to ISO 5660-1.

In a preferred embodiment of the cable according to the third or fourth aspect of the invention, polymer resin (A) comprises an olefin homo- and/or copolymer (A.1) which has a weight average molecular weight M_{w} of 10,000 g/mol or more and a molecular weight distribution MWD of 5 or lower.

In the following, features and preferred embodiment of the cable according to both the first and the second aspect of the invention will be described.

The term “polymer resin” is intended to denote all organic polymeric components of the bedding composition. Suitable organic polymeric components for forming the resin (A) include polyolefins, polyesters, polyethers, polyurethanes and elastomeric polymers such as, for example, ethylene/propylene rubber (EPR), ethylene-propylene-diene monomer rubber (EPDN), thermoplastic elastomer (TPE), butyl rubber (BR) and acrylonitrile rubber (NBR).

Silane-crosslinkable polymers may also be used, i.e. polymers prepared using unsaturated silane monomers having hydrolysable groups capable of cross-linking by hydrolysis and condensation to form silanol groups in the presence of water and, optionally, a silanol condensation catalyst.

Furthermore, low molecular components like waxes, paraffinic oils, stearates etc. might be added to the above mentioned composition, in order to improve processability. However, preferably such materials are not used, as they have a negative impact on the flame retardant properties.

In a preferred embodiment, the polymer resin (A) comprises olefin homo- and/or copolymers. These are, for example, homo- and/or copolymers of ethylene, propylene, alpha-olefins and polymers of butadiene or isoprene.

Olefin homo- and/or copolymer (A.1) preferably has a weight average molecular weight M_{w}, of 15,000 g/mol or more, more preferably has a weight average molecular weight M_{w}, of 25,000 g/mol or more, and even more preferably a weight average molecular weight of 35,000 g/mol or more.

Furthermore, olefin homo- and/or copolymer (A.1) preferably has a molecular weight distribution MWD of 4.5 or lower, more preferably 4.0 or lower, still more preferably 3.5 or lower, and most preferably 3 or lower.

Preferably, olefin homo- and/or copolymer (A.1) is produced in a process using a metallocene polymerisation catalyst.

The weight ratio of olefin homo- and/or copolymer (A.1) to all other constituents of polymer resin (A) is preferably from 5:1 to 1:5, more preferably from 3:1 to 1:3.

Suitable homo- and copolymers of ethylene include low density polyethylene, linear low, medium or high density polyethylene and very low density polyethylene.

In a further preferred embodiment of the invention, polymer resin (A) comprises, more preferably consists of a polar copolymer (A.2), having polar groups selected from acrylic acid, methacrylic acid, acrylates, methacrylates, acrylonitrile, acetates or vinyl acetates and the like.

The polar copolymers are preferably produced by copolymerisation of olefin monomers, preferably ethylene, propylene or butene, with polar monomers comprising C₁- to C₂₀ atoms. However, it may also be produced by grafting a polyolefin with the polar groups. Grafting is e.g. described in U.S. Pat. No. 3,646,155 and U.S. Pat. No. 4,117,195.

Still further, polymer resin (A) preferably comprises a rubber (A.3), such as a butyl rubber, nitrile rubber, EPDM, EPR, styrene-ethylene-butylene-styrene (SEBS), polyisobutylene (PIB) or thermoplastic elastomer (TPE).

In particularly preferred embodiments, polymer resin (A) comprises an olefin homo- and/or copolymer (A.1) and a rubber (A.3), or polymer resin (A) comprises a polar copolymer (A.2), having polar groups selected from acrylic acid, methacrylic acid, acrylates, methacrylates, acrylonitrile, acetates or vinyl acetates and a rubber (A.3), or polymer resin (A) comprises an olefin homo- and/or copolymer (A.1) and a polar copolymer (A.2), having polar groups selected from acrylic acid, methacrylic acid, acrylates, methacrylates, acrylonitrile, acetates or vinyl acetates and a rubber (A.3). Preferably, resin (A) comprises 90 wt. % or more, more preferably consists of any of the blends mentioned above. The blend can be produced by any method known in the art.

Preferably the amount of polymer resin (A) is from 5 to 60 wt %, based on the total weight of the bedding composition, more preferably is from 10 to 30 wt. %, and most preferably is from 12 to 20 wt. %.

The bedding composition of the cable according to the invention comprises an inorganic filler (B). The term “inorganic filler” designates the total of all inorganic compounds present in the composition.

The amount of inorganic filler (B) in the bedding composition is from 40 to 95 wt. %, more preferably from 50 to 95 wt. %, still more preferably from 60 to 90 wt. %, and most preferably from 70 to 85 wt. %, based on the total bedding composition.

The inorganic filler (B) of the bedding composition preferably comprises a hydroxide or hydrated compound (B.1). Preferably the inorganic filler (BA) is a hydroxide or hydrate compound of metal of group II or III of the Periodic System of the Elements. More preferably, the inorganic filler (B.1) is a hydroxide. However, it is more preferred that the inorganic filler (B.1) of the bedding composition is aluminiumtrihydroxide (ATH), magnesiumhydroxide or boehmite. Aluminiumtrihydroxide is most preferred.

Inorganic hydroxide or hydrated compound filler (B.1) of the bedding composition preferably is used in an amount of from 10 to 95 wt %, more preferably of from 10 to 75 wt %, even more preferably of from 15 to 60 wt %, and most preferably of from 20 to 55 wt %, based on the total bedding composition.

The bedding composition of the inventive cable may further comprise an inorganic compound (B.2) which is neither a hydroxide or a hydrated compound. The inorganic compound (B.2) preferably is an inorganic carbonate, more preferably a carbonate of metal of group II of the Periodic System of the Elements, aluminium, zinc and/or a mixture thereof, and most preferably calcium carbonate or magnesium carbonate.

The preferred amount of inorganic compound (B.2) is from 10 wt % to 85 wt %, more preferably from 15 to 60 wt %, most preferably from 20 to 45 wt %, based on the total bedding composition.

In a preferred embodiment, the weight ratio of hydroxide and/or hydrated compound(s) (B.1) to non-hydroxide and/or non-hydrated compound(s) (B.2) in inorganic filler (B) is (100:0) to (0:100), more preferably from (15:85) to (85:15), still more preferably from (25:75) to (75:25), and most preferably from (40:60) to (60:40). preferably from 0.2 to 5, more preferably from 0.4 to 2.0.

In a preferred embodiment, inorganic filler (B) comprises, more preferably consists of, inorganic compounds (B.1) and/or (B.2).

The bedding is preferably stabilized with antioxidants and metal deactivators for improved ageing properties.

According to a preferred embodiment the bedding may comprise one or more, preferably an additive combination (C) to further improve the mechanical properties of a cable. Such a bedding comprising the additive or additive combination is also called a stabilized bedding. The additive or additive combination (C) may be selected from the group consisting of amines which may be hindered amines, hydrazines which may be hindered hydrazines, phenols which may be hindered phenols, hydroxylamines, lactones, phosphites and thioethers. Especially preferred is an additive combination of at least one phosphite, at least one hydrazine and at least one thioether. One example of such an additive combination is a mixture of di-stearyl-thiodipropionate, N,N′-bis-(3,5-di-butyl-4-hydroxyl-phenyl propionyl) hydrazine and tri-(2,4-di-tert-butyl-phenyl)-phosphite.

The additive or additive combination may be contained in the bedding in an amount of from more than 0 to 3 wt %, more preferably 0.01 to 1 wt %, based on the total weight of the bedding.

Surprisingly, such an additive combination in a stabilized bedding can significantly improve the resistance against failure or cracks of an insulated conductor in a mandrel test (“pigtail test”) according to IEC60811-4-2 (1990) and IEC60811-4-1(1985) as described below.

It is also preferred that the cable of the present invention comprises a flame retardant sheath layer. The flame retardant sheath layer is used as a jacketing layer, which surrounds the insulated conductors embedded in the above described bedding composition.

The flame retardant sheath layer can be made of any suitable flame retardant composition known in the art. Such flame retardant polymer compositions are described in e.g. EP 02 029 663, EP 06 011 267 or EP 06 011 269, which are incorporated as reference.

In the present invention, it is preferred that a flame retardant sheath layer is made of a polymer composition, which comprises
i) a polymeric base resin (I),
ii) a silicone-group containing compound (II), and
iii) an inorganic component (III).
   Preferably, as polymeric base resin (I) an olefin homo- and/or copolymer is used, the choice and the composition of which may vary. Of course, olefin polymer may also comprise a mixture of different olefin polymers.

Component (I) is formed by olefin, preferably ethylene, homo- and/or copolymers. These include, for example, homopolymers or copolymers of ethylene, propylene and butene and polymers of butadiene or isoprene. Suitable homopolymers and copolymers of ethylene include low density polyethylene, linear low, medium or high density polyethylene and very low density polyethylene. Suitable ethylene copolymers include such with of C₃- to C₂₀-alpha-olefins, C₁- to C₆-alkyl acrylates, C₁- to C₆-alkyl methacrylates, acrylic acids, methacrylic acids and vinyl acetates. Preferred examples for the alkyl alpha-olefins are propylene, 1-butene, 4-methyl-1-pentene, 1-hexene and 1-octene.

Silane-crosslinkable polymers may also be used, i.e. polymers prepared using unsaturated silane monomers having hydrolysable groups capable of crosslinking by hydrolysis and condensation to form silanol groups in the presence of water and, optionally, a silanol condensation catalyst.

In a further preferred embodiment, component (I) comprises, preferably consists of, an olefin copolymer, preferably a polar olefin copolymer.

Polar groups are defined to be functional groups which comprise at least one element other that carbon and hydrogen.

Preferably, the comonomer content of the olefin copolymer is from 2 to 40 wt %, more preferably is from 4 to 20 wt % and most preferably is from 6 to 12 wt %

Further preferred, the polar copolymer is an olefin/acrylate, preferably ethylene/acrylate, and/or olefin/acetate, preferably ethylene/acetate, copolymer.

It is further preferred that the polar copolymer comprises a copolymer of an olefin, preferably ethylene, with one or more comonomers selected from C₁- to C₆-alkyl acrylates, C₁- to C₆-alkyl methacrylates, acrylic acids, methacrylic acids and vinyl acetate. The copolymer may also contain ionomeric structures (like in e.g. DuPont's Surlyn types).

Further preferred, the polar polymer comprises a copolymer of ethylene with C₁- to C₄-alkyl, such as methyl, ethyl, propyl or butyl, acrylates or vinyl acetate.

It is further preferred that the polar polymer comprises a copolymer of an olefin, preferably ethylene, with an acrylic copolymer, such as ethylene acrylic acid copolymer and ethylene methacrylic acid copolymer.

In addition to ethylene and the defined comonomers, the copolymers may also contain further monomers. For example, terpolymers between acrylates or methacrylates and acrylic acid or methacrylic acid, or acrylates or methacrylates with vinyl silanes, or acrylates or methacrylates with siloxane, or acrylic acid or methacrylic acid with siloxane may be used.

The polar copolymer may be produced by copolymerisation of the polymer, e.g. olefin, monomers with polar comonomers but may also be a grafted polymer, e.g. a polyolefin in which one or more of the comonomers is grafted onto the polymer backbone, as for example acrylic acid or maleic acid anhydride-grafted polyethylene or polypropylene.

In a particularly preferred embodiment, component (I) of the polymer composition used for the flame retardant layer comprises, preferably makes up at least 25 wt %, more preferably at least 35 wt % and most preferably consists of, a copolymer or a mixture of copolymers of an olefin, preferably ethylene, with one or more comonomers selected from the group of non-substituted or substituted acrylic acids according to formula (1):

H₂C═CR—COOH (1)

wherein R is H or an organic substituent, preferably R is H or a hydrocarbon substituent.

More preferably, the type of comonomer is selected from the group of acrylic acid according to formula (1) wherein R is H or an alkyl group, still more preferably R is H or a C₁- to C₆-alkyl substituent.

It is particularly preferred, that the type of comonomer is selected from acrylic acid and methacrylic acid, and most preferably, the comonomer is methacrylic acid.

These copolymers may be crosslinked after extrusion, e.g. by irradiation. Silane-crosslinkable polymers may also be used, i.e. polymers prepared using unsaturated silane monomers having hydrolysable groups capable of crosslinking by hydrolysis and condensation to form silanol groups in the presence of water and, optionally, a silanol condensation catalyst.

In addition to olefin, preferably ethylene, monomers and the above-defined comonomers, the copolymers may also contain further monomers. For example, terpolymers with further, different alpha-olefin comonomers, such as propylene, 1-butene, 4-methyl-1-pentene, 1-hexene and 1-octene, or with vinyl silanes and or siloxane may be used.

Copolymer (I) may be produced by copolymerisation of olefin monomers with the above described comonomers, but may also be a grafted polymer, e.g. a polyolefin in which one or more of the comonomers are grafted onto the polymer backbone, as for example acrylic acid—or methacrylic acid—grafted polyethylene.

It is preferred that polymer component (I) is present in the composition in an amount of 30 to 70 wt %, more preferred of 40 to 70 wt % of the total composition.

The flame retardant composition used in the wire according to the invention further comprises a silicone-group containing compound (II).

In a preferred embodiment, component (II) is a silicone fluid or a gum, or an olefin, preferably ethylene, copolymer comprising at least one silicone-group containing comonomer, or a mixture of any of these compounds.

Preferably, said comonomer is a vinylpolysiloxane, as e.g. a vinyl unsaturated polybishydrocarbylsiloxane.

Silicone fluids and gums suitable for use in the present inventions are known and include for example organopolysiloxane polymers comprising chemically combined siloxy units selected from the group consisting of R₃SiO_{0.5}, R₂SiO, R¹SiO_{1.5}, R¹R₂SiO_{0.5}, RR¹SiO, R¹₂SiO, RSiO_{1.5} and SiO₂ units and mixtures thereof in which each R represents independently a saturated or unsaturated monovalent hydrocarbon radical and each R¹ represents a radical such as R or a radical selected from the group consisting of hydrogen, hydroxyl, alkoxy, aryl, vinyl or allyl radicals.

The organopolysiloxane preferably has a number average molecular weight Mₙ of approximately 10 to 10,000,000. The molecular weight distribution (MWD) measurements were performed using GPC. CHCl₃ was used as a solvent. Shodex-Mikrostyragel (10⁵, 10⁴, 10³, 100 Å) column set, RI-detector and a NMWD polystyrene calibration were used. The GPC tests were performed at room temperature.

The silicone fluid or gum can contain fumed silica fillers of the type commonly used to stiffen silicone rubbers, e.g. up to 50% by weight.

Copolymers of an olefin, preferably ethylene, and at least one silicone-group containing comonomer preferably are a vinyl unsaturated polybis-hydrocarbylsiloxane or an acrylate or methacrylate modified hydrocarbyl siloxane according to formula (2) and (3):

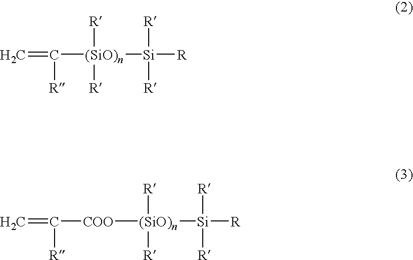

wherein in both (2) and (3) n=1 to 1000 and

R and R′ independently are vinyl, alkyl branched or unbranched, with 1 to 10 carbon atoms; aryl with 6 or 10 carbon atoms; alkyl aryl with 7 to 10 carbon atoms; or aryl alkyl with 7 to 10 carbon atoms. R″ is hydrogen or an alkyl chain.

Such compounds e.g. are disclosed in WO 98/12253 the contents of which is herein enclosed by reference.

Preferably, component (II) is polydimethylsiloxane, preferably having a Mₙ of approximately 1,000 to 1,000,000, more preferably of 200,000 to 400,000, and/or a copolymer of ethylene and vinyl polydimethylsiloxane. These components (B) are preferred due to commercial availability.

The term “copolymer” as used herein is meant to include copolymers produced by copolymerization or by grafting of monomers onto a polymer backbone.

It is preferred that silicone-group containing compound (II) is present in the composition in an amount of 0.5 to 40%, more preferred 0.5 to 10% and still more preferred 1 to 5% by weight of the total composition.

It is, furthermore, preferred that the silicone-group containing compound is added in such an amount that the amount of silicone-groups in the total composition is from 1 to 20 wt. %, more preferably from 1 to 10 wt %.

Component (III) of the flame retardant composition used for the sheath layer may comprise all filler materials as known in the art. Component (III) may also comprise a mixture of any such filler materials. Examples for such filler materials are oxides, hydroxides and carbonates of aluminium, magnesium, calcium and/or barium.

Preferably, component (III) comprises an inorganic compound of a metal of groups 1 to 13, more preferred groups 1 to 3, still more preferred groups 1 and 2 and most preferred group 2, of the Periodic Table of Elements.

The numbering of chemical groups, as used herein, is in accordance with the IUPAC system in which the groups of the periodic system of the elements are numbered from 1 to 18.

Preferably, inorganic filler component (III) comprises a compound which is neither a hydroxide, nor a hydrated compound, more preferred comprises a compound selected from carbonates, oxides and sulphates, and most preferred comprises a carbonate.

Preferred examples of such compounds are calcium carbonate, magnesium oxide and huntite Mg₃Ca(CO₃)₄, with a particular preferred example being calcium carbonate.

Although inorganic filler (III) preferably is not a hydroxide, it may contain small amounts of hydroxide typically less than 5% by weight of the filler, preferably less than 3% by weight. For example there may be small amounts of magnesium hydroxide in magnesium oxide. Furthermore, although filler (III) is not a hydrated compound, it may contain small amounts of water, usually less than 3% by weight of the filler, preferably less than 1% by weight. However, it is most preferred that component (III) is completely free of hydroxide and/or water.

Preferably, component (III) of the flame retardant polymer composition comprises 50 wt % or more of calcium carbonate and further preferred is substantially made up completely of calcium carbonate.

The inorganic filler may comprise a filler which has been surface-treated with an organosilane, a polymer, a carboxylic acid or salt etc. to aid processing and provide better dispersion of the filler in the organic polymer. Such coatings usually do not make up more than 3 wt. % of the filler.

Preferably, the compositions according to the present invention contain less than 3 wt. % of organo-metallic salt or polymer coatings.

It is preferred that inorganic filler (III) is present in the composition in an amount of more than 10 wt %, more preferred of 20 wt % or more, still more preferred of 25 wt % or more.

It is further preferred that inorganic filler (III) is present in the composition in an amount up to 70 wt %, more preferably of up to 55 wt % and most preferably of up to 50 wt %.

Preferably, the average particle size of the inorganic filler is 3 micrometer or below, more preferably 2 micrometer or below, still more preferably 1.5 micrometer or below, and most preferably 0.8 micrometer or below.

In addition to the above-mentioned components (I), (II) and (III), the composition used for the sheath layer may contain further ingredients, such as for example antioxidants and or UV stabilizers, in small amounts.

Furthermore, also other mineral fillers such as glass fibres may be part of the composition of the sheath layer.

Preferably, the total amount of any further ingredients or additives to the composition of the sheath layer, i.e. the total amount of all components apart from (I), (II), and (III), is 10 wt % or less, more preferably 5 wt % or less.

The compositions used in the present invention may be cross-linkable and accordingly cross-linked after extrusion of the polymer layer onto the conductor. It is well known to cross-link thermoplastic polymer compositions using irradiation or cross-linking agents such as organic peroxides and thus the compositions according to the present invention may contain a cross-linking agent in a conventional amount. Silane cross-linkable polymers may contain a silanol condensation catalyst.

The conductors in the cable of the invention are surrounded by an insulating layer, e.g. a thermoplastic or crosslinked layer. Any suitable material known in the art can be used for the production of such insulating layer, e.g. polypropylene, polyethylene thermoplastic or crosslinked by the use of silanes, peroxides or irradiation.

The insulation layer in a preferred embodiment is a flame retardant layer, more preferably made from a composition as already described for the flame retardant sheath layer.

Most commonly, the insulation layer is silane crosslinked, as it is described for example in U.S. Pat. Nos. 4,413,066; 4,297,310; 4,351,876; 4,397,981; 4,446,283; and 4,456,704.

The conductors used in the cable of the present invention preferably are conductors of copper or aluminium.

The cables of the present invention may be produced by any method known in the art. Most commonly the insulated conductors are produced separately as they need to be twisted (in general the cables consist of many—most commonly 3 insulated conductors, wherein the insulation layers have different colours). The insulated conductors are twisted together in a separate production step. The twisted parts are then coated by an extruded bedding layer, which commonly directly is coated with the extruded sheath. It might also happen that this is done in two step, probably due to that the producer is lacking modern equipment. In order to avoid the bedding to stick to its surrounding layers talcum is often “powdered” onto the insulated conductors and bedding layers just before the bedding and sheathing extrusion step.

The bedding layer may also be present in form of an additional layer applied between the one or more insulated conductors and an outer sheath layer.

The cable of the present invention preferably is a low voltage cable, used as e.g. control, energy or a telecommunication cable.

The present invention is further illustrated by reference to the following figures and examples:

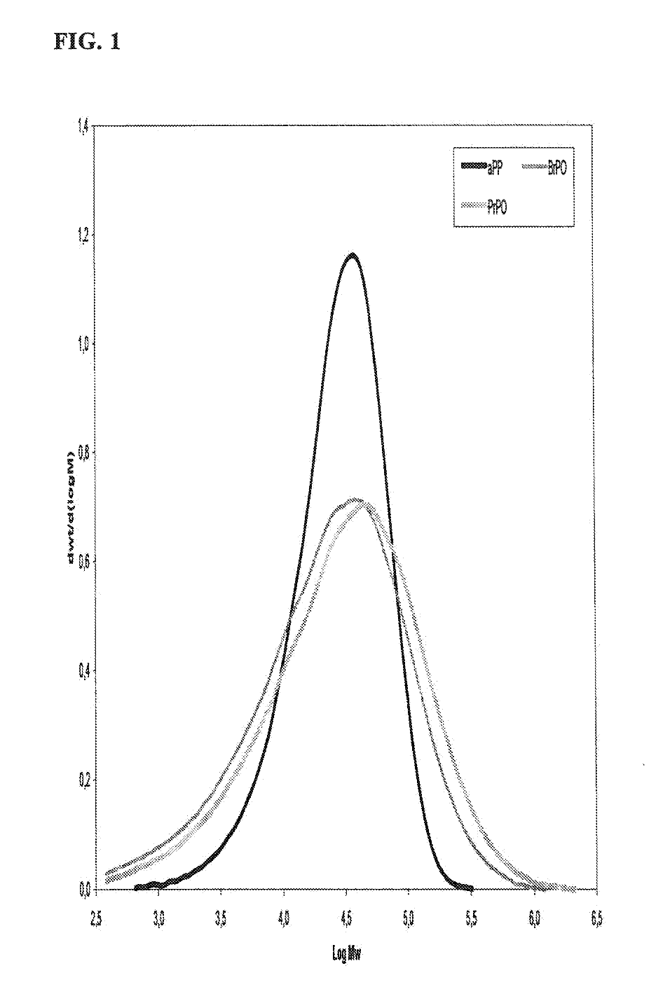

FIG. 1: Molecular weight distribution of aPP, BrPO, and PrPO used as polymers (A.1) in the examples/comparative examples;

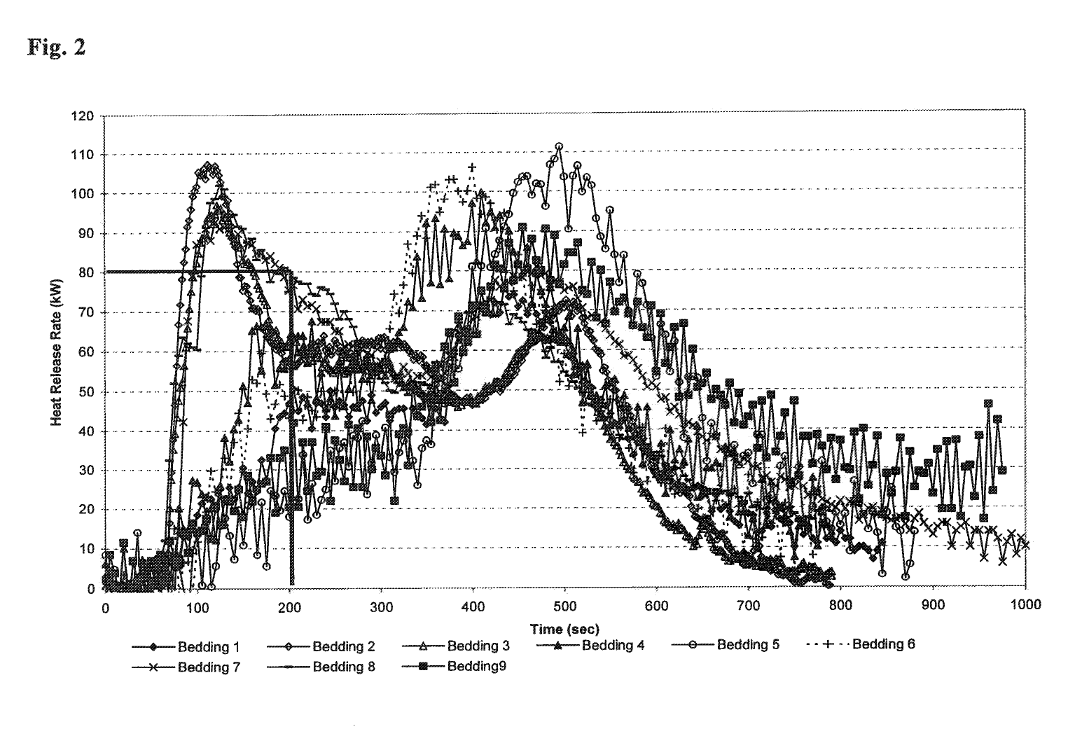

FIG. 2: Heat release rate HRR as function of time of plaques produced with bedding compositions 1 to 8 measured according to ISO 5660-1.

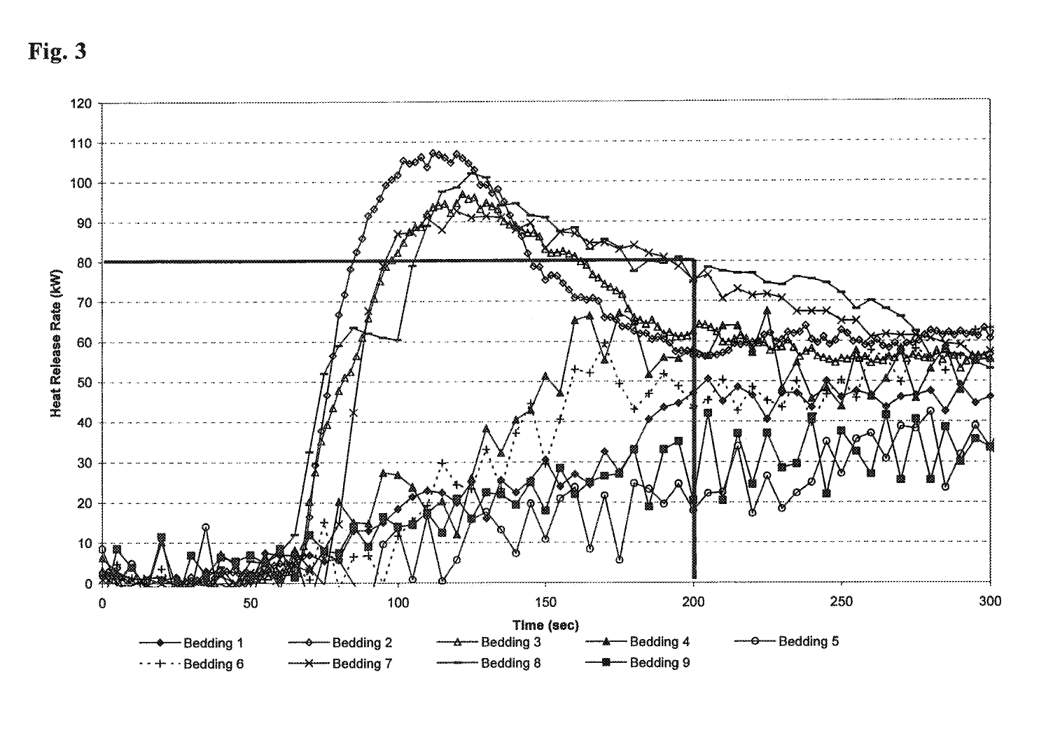

FIG. 3: Enlargement of FIG. 2.

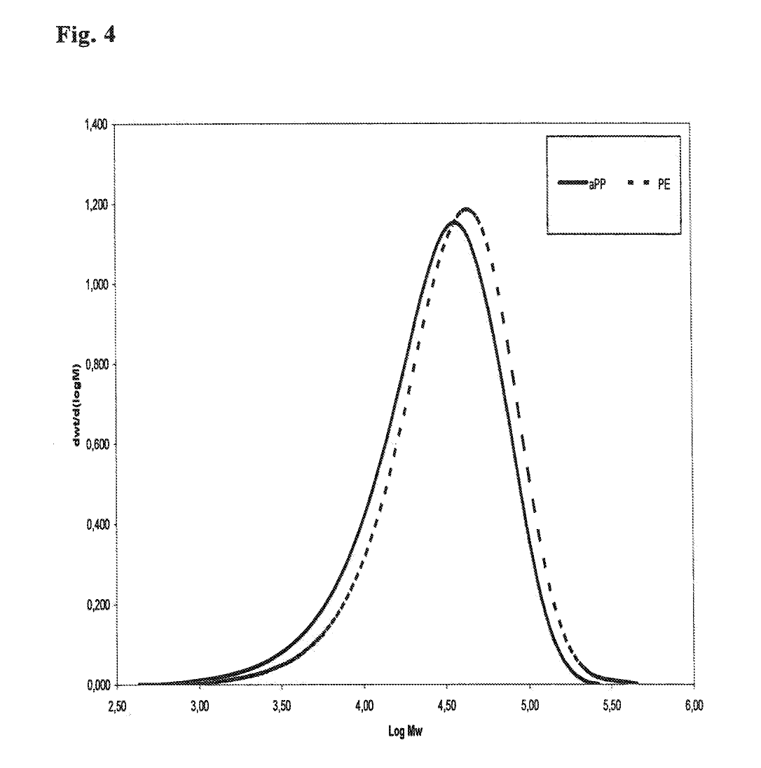

FIG. 4: Molecular weight distribution of aPP and PE as polymers (A.1) in the examples

### METHOD AND EXAMPLES

### 1. Compression Moulding

The bedding compounds were pressed into plaques (100×100×3 mm³) in a Collins press (low pressure (20 bar) at 100° C. during one minute followed by high pressure (300 bar) during five minutes at the same temperature). Cooling rate was 10° C./minute under high pressure.

### 2. Cone Calorimetry

The pressed plaques (100×100×3 mm³) were tested in a cone calorimeter according to ISO 5660-1. The cone was in a horizontal position. A burner capacity of 50 kW/m² was used. A retainer frame was used.

### 3. Measurement of M_{w} and MWD

M_{w} is defined as weight average molecular weight, Mₙ is defined to be the number average molecular weight, and the molecular weight distribution MWD is defined as M_{W}/Mₙ. M_{w}, Mₙ and MWD were measured with GPC, using the following equipment and parameters:

Test Conditions for GPC Measurements on aPP, Br PO and PrPO (FIG. 1)

### Equipment: Alliance 2000GPCV no.W-4411 (C1115)

Detector: Refractive index (RI) and Visc.-detector

### Calibration: Narrow MWD PS(C1115_{—}122006C)

Columns: 3×PLgel 10Am MIXED-B, 300*7.5 mm from Polymer Lab (140° C.)

### Processing Method: GPC

### Test Conditions for GPC Measurements on aPP and PE (FIG. 4):

Equipment: Alliance 2000 GPCV no. W-4411 (C1115)
Detector: Refractive index (RI) and viscosity detector

### Calibration: Narrow MWD PS(C1115_test_HARM)

### Columns: 1×TSK-GEL G7000H and 2×TSK-GEL GMHx1-HT,

300×7,8 mm from Tosoh Bioscience (140° C.)
Processing Method: dRI only

### 4. Compounding of Compositions

The bedding compositions according to the invention and for comparative purpose were produced by mixing together the components in a Banbury kneader (375 dm³). Materials were processed until a homogenous melt was accomplished and then mixed for another 2 minutes. The still hot materials were taken from the Banbury mixer onto a two-roll mill to produce a slab, from which plaques for testing were prepared.

### 5. Polymer Compositions

The used bedding compositions (inventive and comparative) are explained in more detail in Table 1 and 2 and its footnotes.

The resins (A) used in the examples are given in Table 1.

As inorganic filler (B.1) aluminum trihydroxide (ATH) was used.

As inorganic filler (B.2) calcium carbonate was used.

As additive combination (C) a mixture of Irganox® PS802, Irganox® MD 1024 and Irgafos® 168 was used.

As insulation and sheathing layer commercial compounds intended for wire and cable applications were used which are all produced by Borealis.

“Ins 1” is a flame retardant insulation based on Borealis Casico® technology consisting of a combination of polyethylene, calcium carbonate and silicone elastomer, and has a melt flow rate, MFR (2.16 kg, 190° C.) of 0.9 g/10 min and a density of 1150 kg/m³.

“Ins 2” is an insulation for cable applications which is a combination of a silane-crosslinkable polyethylene according to Borealis' Visico® technology which has a MFR₂.16, 190° C. of 1.0 g/10 min and a density of 923 kg/m³ with a catalyst masterbatch based on Borealis' Ambicat product containing a condensation catalyst. 5 wt % of the catalyst masterbatch was dry mixed with 95 wt % of the base silane-crosslinkable polyethylene described above. The freshly prepared cables were conditioned sufficiently for crosslinking the resin.

As a sheath, a flame retardant polyethylene based on the Casico® technology was used, consisting of a combination of polyethylene, calcium carbonate and silicone elastomer, which has a MFR_{2.16}, 190° C. of 0.4 g/10 min and a density of 1150 kg/m³.

### 6. Melt Flow Rates

Melt flow rates were measured in accordance with ISO 1133 at the levels and temperatures indicated.

### 7. Production of Cables

The insulation layer made of “Ins 2” having a thickness of 0.7±0.1 mm was extruded onto a 1.5 mm² copper conductor on a Francis Shaw 60 mm/24 D wire line. Three cores were twisted together by the use of a Northampton Twister. The bedding (Extruder: Maillefer 45 mm/30 D) and sheath (Extruder Mapre 60 mm/24 D) layers were applied by a tandem extrusion process. In order to avoid adhesion between the bedding and its surrounding layers talcum were “powdered” onto the cores and bedding layer just before the bedding and sheath layer were applied. The insulation layer made of “Ins 1” had a thickness of 0.5±0.1 mm. All other conditions were the same.

### 8. Ageing of Cable Samples

The cables were aged in a cell oven at 100° C. with an fan. The ageing time varied from 0, 28, 42, 56 to 100 days. The cables were hanging in the oven and had no direct contact with each other nor with any other part of the oven except for the hanging rod.

### 9. Mandrel Testing

The mandrel test (also referred to as “pigtail test”) was performed on the insulated conductor after the removal of any remaining sheathing, talc and bedding residue. The test was performed according to IEC60811-4-2 (1990) and IEC60811-4-1 (1985). The results were classified into “pass” or “fail” after visual inspection of samples with a light microscope. If no cracks or any other failure could be abserved the sample had passed the test.

The insulation layer was widened around a mandrel. The severe bending of the insulated conductor caused a very high stress which led, in the case of the comparative samples, to mechanical defects. All mechanical defects were classified according to the standards indicated above.

TABLE 1
(all data in weight %)

| | | Bedding 2 | Bedding 3 | | | | Bedding 7 | Bedding 8 | |
|---|---|---|---|---|---|---|---|---|---|
| | Bedding 1 | (Comp.) | (Comp.) | Bedding 4 | Bedding 5 | Bedding 6 | (Comp.) | (Comp) | Bedding 9 |
| aPP¹ | 8 | | | | | | | | |
| BrPO² | | 8 | | | | | | | |
| PrPO³ | | | 8 | | | | | | |
| Butyl rubber⁴ | 5 | 5 | 5 | | | | | | 5 |
| PE¹² | | | | | | | | | 8 |
| Zn-stearate | 1.5 | 1.5 | 1.5 | 1.5 | 1.5 | 1.5 | 1.5 | 1.5 | 1.5 |
| Zn-borate | 1.5 | 1.5 | 1.5 | | | | | | 1.5 |
| CaCO₃⁵ | 32 | 32 | 32 | 32.1 | 32.1 | 32.1 | 32.1 | 32.1 | 32 |
| ATH⁶ | 52 | 52 | 52 | 49.4 | 49.4 | 49.4 | 49.4 | 49.4 | 52 |
| EMA-1⁷ | | | | | 13.6 | | 11.6 | 8.6 | |
| EMA-2⁸ | | | | | | 13.6 | | | |
| EBA⁹ | | | | 13.6 | | | | | |
| NBR¹⁰ | | | | 3.4 | 3.4 | 3.4 | 3.4 | 3.4 | |
| FR additive¹¹ | | | | | | | 2 | 5 | |

¹atactic polypropylene produced with a metallocene catalyst, M_{w} = 40,000 g/mol, Mₙ = 18,000 g/mol, MWD = 2.2;
²1-butene rich amorphous poly-alpha-olefin, M_{w} = 50,000 g/mol, Mₙ = 8,300 g/mol, MWD = 6.3;
³propylene rich amorphous poly-alpha-olefin from Degussa AG, M_{w} = 70,000 g/mol, Mₙ = 10,000 g/mol, MWD = 7.0;
⁴Butyl rubber, Mooney viscosity ML₍₁₊₈₎ (125° C.) = 50
⁵CaCO₃ average particle size 2.3 micrometer (0-10 micrometer), CaCO₃ content 88 wt. % (MgCO₃: 1 wt. %, Fe₂O₃: 0.5 wt. %, HCl insolubies: 10 wt. %);
⁶ATH, aluminum trihydroxide: average particle size 12.5 micrometer (0-40 micrometer), Al(OH)₃ content: 99.6 wt. %;
⁷Ethylene-methylacrylate (EMA-1) copolymer containing 20 wt-% methylacrylate, MFR (2.16 kg, 190° C.) = 2 g/10 min;
⁸Ethylene-methylacrylate (EMA-2) copolymer containing 20 wt.-% methylacrylate, MFR (2.16 kg, 190° C.) = 20 g/10 min;
⁹Ethylene-butyl-acrylate copolymer containing 35 wt-% butylacrylate, MFR (2.16 kg, 190° C.) = 40 g/10 min;
¹⁰Nitrile-butadiene-rubber, Mooney viscosity ML_{10 (1+4)} (100° C.) = 40, nitrile content 35 w-%;
¹¹tri-2-ethylhexyl-phosphate
¹²Ethylene-Octene Copolymer, M_{w} = 45.000 g/mol, Mₙ = 22.000 g/mol, MWD = 2.1; MFR (2.16 kg, 190° C.) = 30 g/10 min, density = 885 kg/m³

Bedding compositions 1, 4, 5, 6 and 9 are according to the invention. They show a HRR of lower than 80 kW within the first 200 sec. This is shown in FIG. 3 [enlarged diagram of HRR]. The figure also show that comparative bedding compositions 2, 3, 7 and 8 have a significantly higher HRR than the inventive bedding compositions.

TABLE 2
Formulation of stabilised beddings

| | Bedding 1 | | | | Bedding 13 | | | | |
|---|---|---|---|---|---|---|---|---|---|
| | (Comp.) | Bedding 10 | Bedding 11 | Bedding 12 | (Comp.) | Bedding 14 | Bedding 15 | Bedding 16 | Bedding 17 |
| aPP | 8 | 8 | 8 | 8 | 8 | 8 | 8 | 8 | |
| PE | | | | | | | | | 8 |
| Butyl rubber | 5 | 5 | 5 | 5 | 5 | 5 | 5 | 5 | 5 |
| Zn-stearate | 1.5 | 1.5 | 1.5 | 1.5 | 1.5 | 1.5 | 1.5 | 1.5 | 1.5 |
| Zn-borate | 1.5 | 1.5 | 1.5 | 1.5 | | | | | 1.5 |
| CaCO₃ | 32 | 30.9 | 31.45 | 31.78 | | | | | 31.78 |
| CaCO₃¹³ | | | | | 85.5 | 84.4 | 84.95 | 85.28 | |
| ATH | 52 | 52 | 52 | 52 | | | | | 52 |
| Irganox PS802¹⁴ | | 0.6 | 0.3 | 0.12 | | 0.6 | 0.3 | 0.12 | 0.12 |
| Irganox MD 1024¹⁵ | | 0.4 | 0.2 | 0.08 | | 0.4 | 0.2 | 0.08 | 0.08 |
| Irgafos 168¹⁶ | | 0.1 | 0.05 | 0.02 | | 0.1 | 0.05 | 0.02 | 0.02 |

¹³CaCO₃: Average particle size 3.0 μm (0-23 μm), CaCO₃ content: 99.5 wt. % (MgCO₃: 0.3 wt. %, Fe₂O₃: 0.05 wt. %, HCl insolubles: 0.3 wt. %
¹⁴Irganox ® PS802: Di-stearyl-thiodipropionate manufactured by Ciba Speciality Chemistry
¹⁵Irganox ® MD 1024: N,N′-Bis-(3,5-di-butyl-4-hydroxyl-phenylpropionyl) hydrazine manufactured by Ciba Speciality Chemistry
¹⁶Irgafos ® 168: Tri-(2,4-di-tert-buryl-phenyl)-phosphite manufactured by Ciba Speciality Chemistry

TABLE 3
Pigtail testing results (x: failure, cracks visible after the pigtail
test, ✓: pass, no cracks visible after the pigtail test)

| | >>Ins 1>> | | | >>Ins 2>> | | | |
|---|---|---|---|---|---|---|---|
| | 28 | 42 | 56 | 28 | 42 | 56 | 100 |
| Pigtail | days | days | days | days | days | days | days |
| Bedding 1 | ✓ | | X | ✓ | | X | |
| (Comp.) | | | | | | | |
| Bedding 10 | ✓ | ✓ | ✓ | ✓ | ✓ | ✓ | ✓ |
| Bedding 11 | ✓ | ✓ | ✓ | ✓ | ✓ | ✓ | ✓ |
| Bedding 12 | ✓ | ✓ | ✓ | ✓ | ✓ | ✓ | ✓ |
| Bedding 13 | — | | — | ✓ | | X | |
| (Comp.) | | | | | | | |
| Bedding 14 | | | | ✓ | ✓ | ✓ | ✓ |
| Bedding 15 | | | | ✓ | ✓ | ✓ | ✓ |
| Bedding 16 | | | | ✓ | ✓ | ✓ | ✓ |
| Bedding 17 | | | | ✓ | ✓ | ✓ | — |

Pigtail testing of the insulation shows that non-stabilised bedding compositions (Comparative examples Bedding 1 and Bedding 13) already display cracks after 56 days of ageing (8 weeks). In contrast thereto, the stabilised beddings (according to the invention: Bedding 10-12 and 14-17) showed good mechanical performance even after 56 days.

The above results show that a stabilized bedding according to the present invention significantly improves crack resistance in the pigtail test compared to bedding compositions which are not stabilized with an additive combination.

1. A cable comprising one or more insulated conductors which are embedded in a bedding composition, said bedding composition comprises:
a) a polymer resin and
b) an inorganic filler;
wherein the polymer resin comprises an olefin homo- and/or copolymer which has a weight average molecular weight M_{w}, of 10,000 g/mol or more and a molecular weight distribution MWD of 5 or lower.

2. A cable comprising one or more insulated conductors which are covered by a layer provided between said one or more insulated conductors and an outer sheath layer, wherein the layer comprises a bedding composition comprising:
(a) a polymer resin and
(b) an inorganic filler;
wherein the polymer resin comprises an olefin homo- and/or copolymer which has a weight average molecular weight M_{w}, of 10,000 g/mol or more and a molecular weight distribution MWD of 5 or lower.

3. A cable comprising one or more insulated conductors which are embedded in a bedding composition, said bedding composition comprising:
(a) a polymer resin and
(b) an inorganic filler;
wherein the heat release rate HRR of the bedding composition at any time within the period from 0 s to 200 s after ignition does not exceed a maximum of 80 kW measured with cone calorimetry according to ISO 5660-1.

4. A cable comprising one or more insulated conductors which are covered by a layer provided between said one or more insulated conductors and an outer sheath layer, the layer comprising a bedding composition;
wherein the heat release rate HRR of the bedding composition at any time within the period from 0 s to 200 s after ignition does not exceed a maximum of 80 kW measured with cone calorimetry according to ISO 5660-1.

5. The cable according to claim 3, wherein the polymer resin comprises an olefin homo- and/or copolymer which has a weight average molecular weight M_{w}, of 10,000 g/mol or more and a molecular weight distribution MWD of 5 or lower.

6. The cable according to claim 1, wherein said olefin homo- and/or copolymer has a weight average molecular weight M_{w} of 25,000 g/mol or more.

7. The cable according to claim 1, wherein said olefin homo- and/or copolymer has a molecular weight distribution MWD of 4.5 or lower.

8. The cable according to claim 1, wherein the amount of said polymer resin is from 5 to 60 wt %.

9. The cable according to claim 6, wherein the amount of the polymer resin is from 5 to 30 wt %.

10. The cable according to claim 1, wherein the weight ratio of said olefin homo- and/or copolymer to all other constituents of said polymer resin is from 5:1 to 1:5.

11. The cable according to claim 1, wherein the amount of said inorganic filler is from 40 to 95 wt %, based on the total bedding composition.

12. The cable according to claim 9, wherein the amount of said inorganic filler is from 50 to 95 wt %, based on the total bedding composition.

13. The cable according to claim 1, wherein said inorganic filler comprises a hydroxide and/or hydrated compound.

14. The cable according to claim 11, wherein said inorganic filler further comprises a non-hydroxide and/or non-hydrated compound.

15. The cable according to claim 14 wherein the weight ratio of said hydroxide and/or hydrated compound(s) to said non-hydroxide and/or non-hydrated compounds in said inorganic filler is from 85:15 to 15:85.

16. The cable according to claim 1, wherein the cable further comprises an additive combination selected from the group consisting of hindered amines, hindered hydrazines, hindered phenols, hydroxylamines, lactones, phosphites and thioethers.

17. The cable according to claim 1, wherein the cable further comprises a flame retardant sheath layer.

18. The cable according to claim 17, wherein the flame retardant sheath layer comprises a polymer composition, which comprises:
i) a polymeric base resin,
ii) a silicone-group containing compound, and
iii) an inorganic component.

19. The cable according to claim 1, wherein the cable is a low voltage cable.

20. (canceled)

21. A bedding composition used as a bedding for one or more insulated conductors of a cable, the bedding composition comprising:
a) a polymer resin and
b) an inorganic filler,
wherein the polymer resin comprises an olefin homo- and/or copolymer which has a weight average molecular weight M_{w}, of 10,000 g/mol or more and a molecular weight distribution MWD of 5 or lower.

22. A bedding composition used as a bedding for one or more insulated conductors of a cable, wherein the heat release rate HRR of the bedding composition at any time within the period from 0 s to 200 s after ignition does not exceed a maximum of 80 kW measured with cone calorimetry according to ISO 5660-1.

23. The cable according to claim 4, wherein the polymer resin comprises an olefin homo- and/or copolymer which has a weight average molecular weight M_{w} of 10,000 g/mol or more and a molecular weight distribution MWD of 5 or lower.

24. The cable according to claim 2, wherein said olefin homo- and/or copolymer has a weight average molecular weight M_{w} of 25,000 g/mol or more.

25. The cable according to claim 3, wherein said olefin homo- and/or copolymer has a molecular weight distribution MWD of 4.5 or lower.

26. The cable according to claim 2, wherein the amount of said polymer resin is from 5 to 60 wt %.

27. The cable according to claim 2, wherein the weight ratio of said olefin homo- and/or copolymer to all other constituents of said polymer resin is from 5:1 to 1:5.

28. The cable according to claim 2, wherein the amount of said inorganic filler is from 40 to 95 wt %, based on the total bedding composition.

29. The cable according to claim 2, wherein said inorganic filler comprises a hydroxide and/or hydrated compound.

30. The cable according to claim 2, wherein the cable further comprises an additive combination selected from the group consisting of hindered amines, hindered hydrazines, hindered phenols, hydroxylamines, lactones, phosphites and thioethers.

31. The cable according to claim 2, wherein the cable further comprises a flame retardant sheath layer.

32. The cable according to claim 2, wherein the cable is a low voltage cable.
